(19) United States
(12) Patent Application Publication
(10) Pub. No.: US 2006/0109688 A1
(43) Pub. Date: May 25, 2006

(54) Liquid crystal display apparatus

(75) Inventor: Yoshiaki Oosawa, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/271,789

(22) Filed: Nov. 14, 2005

(30) Foreign Application Priority Data
Nov. 25, 2004 (JP) 2004-340653

(51) Int. Cl. F21V 7/04

(52) U.S. Cl. 362/632

(57) ABSTRACT

A planar light source device comprises a cold cathode fluorescent tube having ends, which are held by holders, a light guide having an end surface facing the cold cathode fluorescent tube and the holders, a light exit surface from which light exits, and a counter surface opposing to the light exit surface, and a reflecting sheet, which is arranged to face the counter surface. The reflecting sheet has tongue portions arranged between the light guide and each of the holders.

### CROSS-REFERENCE TO RELATED APPLICATIONS

This application is based upon and claims the benefit of priority from prior Japanese Patent Application No. 2004-340653, filed Nov. 25, 2004, the entire contents of which are incorporated herein by reference.

### BACKGROUND OF THE INVENTION

1. Field of the Invention

The present invention relates to a planar light source device which irradiates a liquid crystal display panel, and to a liquid crystal display apparatus having the planar light source device.

2. Description of the Related Art

Generally, a liquid crystal display apparatus has a liquid crystal display panel, a planar light source device which illuminates the liquid crystal display panel from behind it, and a frame which supports the liquid crystal display panel and the planar light source device.

The planar light source device has a cold cathode fluorescent tube serving as a light source, and a light guide which converts light received from the cold cathode fluorescent tube to planar light. The cold cathode fluorescent tube has a high voltage electrode and a low voltage electrode respectively at the two ends thereof, and the ends are held by a holder. The cold cathode fluorescent tube has a connecting portion connected to an external device via a feeding wire, and the electrodes are connected to the connecting portion. The holder has a holding portion, which holds the electrodes and the connecting portion.

The light guide has an end surface opposing to the cold cathode fluorescent tube and the holder, a light exit surface, from which the light exits, and a counter surface opposing to the light exit surface. The end surface is arranged in contact with the holding portion of the holder. An optical sheet is arranged to face at least one of the light exit surface and the counter surface. For example, the optical sheet on the light exit surface may be a light collecting sheet which collects the light that exits from the light guide, or a light diffusing sheet which diffuses the exit light. The optical sheet on the counter surface may be, for example, a reflecting sheet, which reflects the light leaked through the counter surface, so as to return the light towards the light guide.

Conventionally, a cold cathode fluorescent tube of the gas pressure of 80 Torr is used as a light source. In recent years, there is a demand for implementing a planar light source device whose brightness is high from the startup time. Therefore, a planar light source device has been developed, which realizes high brightness at a low temperature, using a cold cathode fluorescent tube of the gas pressure of 120 Torr.

However, if the cold cathode fluorescent tube of the gas pressure of 120 Torr is turned on at a temperature of, for example, 65° C., heat may generate in the electrode portions and the connecting portion in the cold cathode fluorescent tube, and the holding portion of the holder may be heated to a temperature of about 105° C. At this time, if the light guide is formed of heat-resistant acrylic, the portion where the end surface of the light guide is in contact with the holding portion of the holder may be thermally deformed, since acrylic has heat resistance up to about 105° C.-117° C.

Jpn. Pat. Appln. KOKAI Publication No. 2003-43933 proposes a method for transferring the heat generated by the light source to the reflector through the holder, thereby externally radiating the heat.

In the above method, however, since the holder is directly in contact with the end surface of the light guide, the heat transmits from the holder to the light guide. Therefore, it is difficult to prevent the light guide from thermally deforming.

### BRIEF SUMMARY OF THE INVENTION

The present invention was made to solve the problem of the prior art described above. An object of the present invention is to provide a planar light source device, in which the brightness at the startup time is high and the light guide is prevented from thermally deforming, and also to provide a liquid crystal display apparatus comprising the planar light source device.

According to an aspect of the present invention, there is provided a planar light source device comprising: a cylindrical light source having ends, which are held by a holder; a light guide having an end surface facing the light source and the holder, a light exit surface from which light exits, and a counter surface opposing to the light exit surface; and an optical sheet, which is arranged to face at least one of the light exit surface and the counter surface, wherein the optical sheet has a tongue portion arranged between the light guide and the holder.

According to another aspect of the present invention, there is provided a liquid crystal display apparatus comprising: a liquid crystal display panel including a display region in which a plurality of pixels are arrayed; a planar light source device, which illuminates the liquid crystal display panel from behind it; and a frame which supports the liquid crystal display panel and the planar light source device, the planar light source device comprising: a cylindrical light source having ends, which are held by a holder; a light guide having an end surface facing the light source and the holder, a light exit surface from which light exits, and a counter surface opposing to the light exit surface; and an optical sheet, which is arranged to face at least one of the light exit surface and the counter surface, wherein the optical sheet has a tongue portion arranged between the light guide and the holder.

According to the present invention, it is possible to provide a planar light source device, in which the brightness at the startup time is high and the light guide is prevented from thermally deforming, and also to provide a liquid crystal display apparatus comprising the planar light source device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external perspective view schematically showing a liquid crystal display apparatus according to an embodiment of the present invention;

FIG. 2 is an exploded perspective view of the liquid crystal display apparatus shown in FIG. 1;

FIG. 3A is an exploded perspective view of the planar light source device shown in FIG. 2;

FIG. 3B is a partially enlarged view of the reflecting sheet shown in FIG. 3A;

FIG. 4 is a plan view of the planar light source device shown in FIG. 3A;

FIG. 5 is a partially enlarged view showing a portion near an end of the cold cathode fluorescent tube of the planar light source device shown in FIG. 4; and

FIG. 6 is a cross-sectional view of the cold cathode fluorescent tube shown in FIG. 5 taken along the line VI-VI.

### DETAILED DESCRIPTION OF THE INVENTION

A planar light source device and a liquid crystal display apparatus having the same, according to an embodiment of the present invention, will be described with reference to the accompanying drawings.

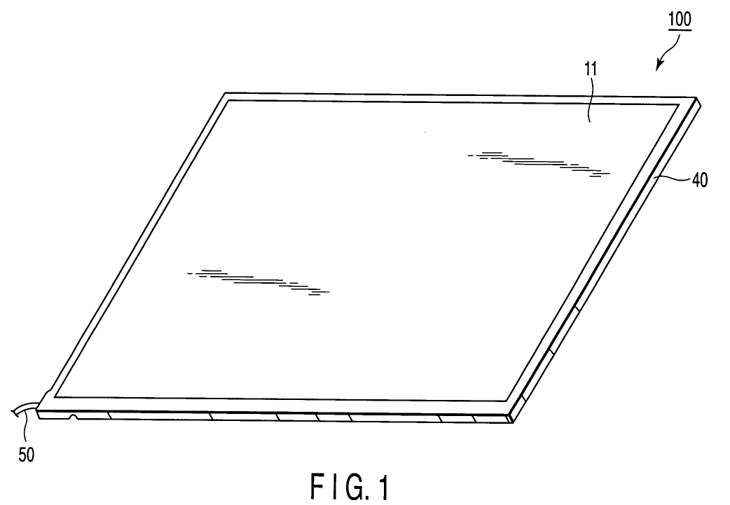

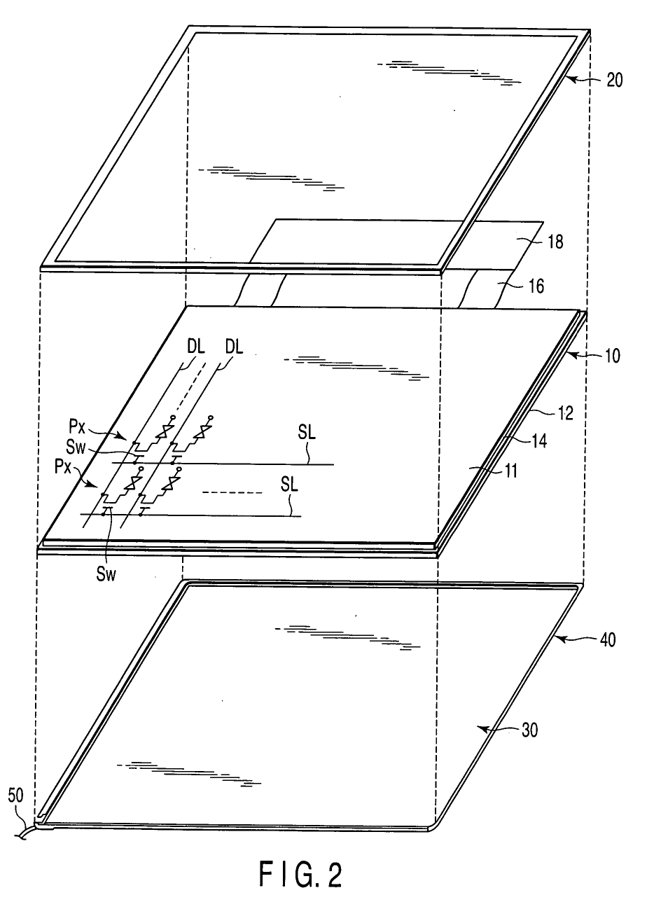

FIG. 1 is a schematic perspective view of a liquid crystal display apparatus 100 according to the embodiment. FIG. 2 is an exploded perspective view of the liquid crystal display apparatus 100 shown in FIG. 1. As shown in FIGS. 1 and 2, the liquid crystal display apparatus 100 is approximately rectangular. It comprises a liquid crystal display panel 10; a planar light source device 30 which illuminates the liquid crystal display panel 10 from behind it; a frame 40 which supports the liquid crystal display panel 10 and the planar light source device 30; and a bezel cover 20 which is attached to the frame 40 and holds the peripheral portion of the liquid crystal display panel 10.

The liquid crystal display panel 10 comprises an array substrate 12 and a counter substrate 14, which are arranged opposite to each other. A liquid crystal layer is sandwiched between the array substrate 12 and the counter substrate 14. A polarizing plate (not shown) is attached to the outer surface of each of the array substrate 12 and the counter substrate 14.

The liquid crystal display panel 10 has a display section 11, which displays images. The display section 11 comprises a plurality of display pixels PX arranged in a matrix. An array substrate 12 has, in the display section 11, a plurality of scanning lines SL extending in a row direction of the pixels PX, a plurality of signal lines DL extending in a column direction of the pixels PX, and a plurality of switching elements Sw provided in the respective pixels PX. In each pixel, the switching element is arranged near the intersection between the scanning line SL and the signal line DL. The switching element Sw comprises a thin film transistor (TFT) having, for example, a polysilicon semiconductor layer.

A rectangular flat circuit board 18 is electrically connected to a side end of the liquid crystal display panel 10 via a flexible board 16 having an elongated rectangular flat shape, so that it supplies a driving signal to the liquid crystal display panel 10. The circuit board 18 is arranged on the back side of the planar light source device 30 by means of the flexible board 16, which is bent to the back surface of the planar light source device 30.

The liquid crystal display panel 10 is stacked on the planar light source device 30 and held in the frame 40. The bezel cover 20 is attached to the frame 40 over the liquid crystal display panel 10. The planar light source device 30 is approximately rectangular, and the front surface thereof faces the back surface of the liquid crystal display panel 10. Thus, the planar light source device 30 illuminates the liquid crystal display panel 10 from behind it.

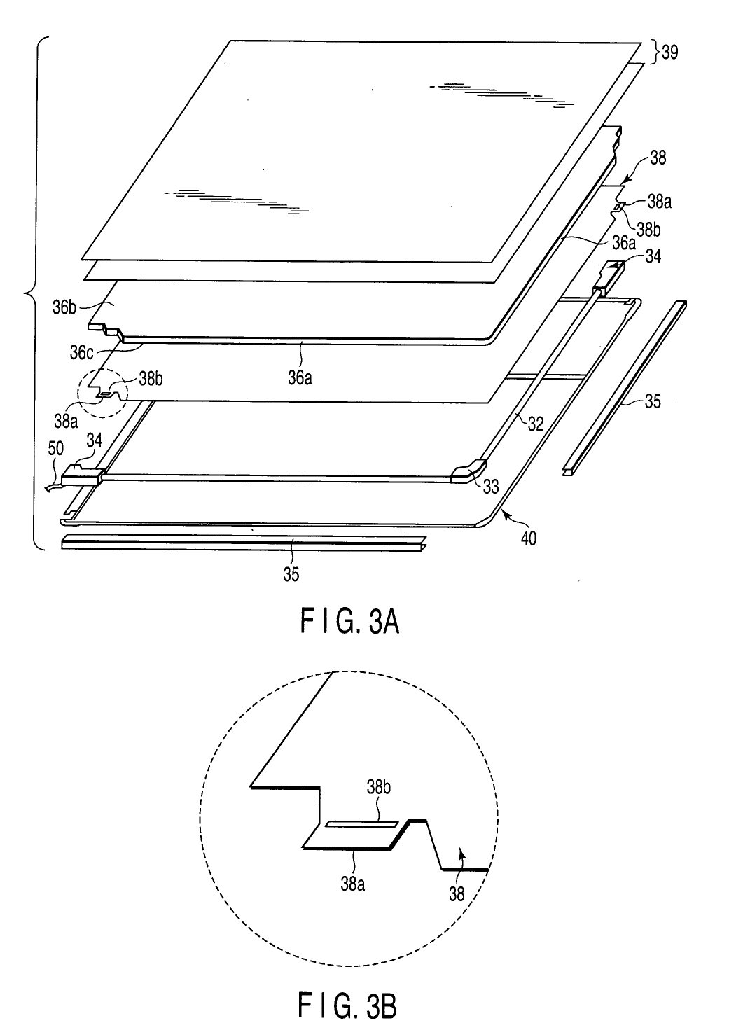

FIG. 3A is an exploded perspective view of the planar light source device 30 shown in FIG. 2. As shown in FIG. 3A, the planar light source device 30 has a cold cathode fluorescent tube 32 serving as a light source, a light guide 36 which guides light emitted from the cold cathode fluorescent tube 32 to the liquid crystal display panel 10, and optical sheets 38 and 39 arranged on the main and back surfaces of the light guide 36.

The cold cathode fluorescent tube 32 is a cylindrical light source, which is L-shaped. The gas pressure in the cold cathode fluorescent tube 32 is 120 Torr in this embodiment. The two ends of the cold cathode fluorescent tube 32 are held by holders 34 made of rubber, which has heat resistance up to about 250° C. A corner portion of the cold cathode fluorescent tube 32 is held by support member 33. Each of the reflectors 35 is attached between holder 34 and support member 33. The reflector 35 has a substantially U-shaped cross section in a direction perpendicular to the longitudinal direction of the cold cathode fluorescent tube 32. It holds the light guide 36 from above and below and surrounds the cold cathode fluorescent tube 32.

The light guide 36 is formed of heat resistant acrylic, having heat resistance up to, for example, 105° C.-117° C. The light guide 36 has end surfaces 36a, which faces the cold cathode fluorescent tube 32 and the holders 34; a light exit surface 36b, from which the light exits; and a counter surface 36c opposing to the light exit surface 36b. Portions of the end surfaces 36a which face the holders 34 are cut out in accordance with the shapes of the holders 34.

The optical sheet 39, arranged on the light exit surface 36a (main surface) of the light guide 36, imparts predetermined optical characteristics to the light that exits from the light exit surface 36a of the light guide 36. For example, the optical sheet 39 may be a light collecting sheet which collects the light, or a light diffusing sheet which diffuses the light. The reflecting sheet 38, arranged on the counter surface 36c (back surface) of the light guide 36, reflects the light, which is leaked through the counter surface 36c, so as to return the light to the light guide 36. In this embodiment, the reflection sheet 38 has a thickness of about 0.15 mm and is formed of polyethylene terephthalate (PET), having heat resistance to a temperature of 140° C. or higher.

FIG. 3B is an enlarged view showing a part of the reflecting sheet 38 shown in FIG. 3A. As shown in FIG. 3B, the reflecting sheet 38 has rectangular tongue portions 38a, respectively projecting from edge portions thereof adjacent to the holders 34. Each tongue portion 38a has a slit 38b in its proximal end portion thereof. The reflecting-sheet 38, the light guide 36 and the optical sheet 39 are stacked and held in the frame 40.

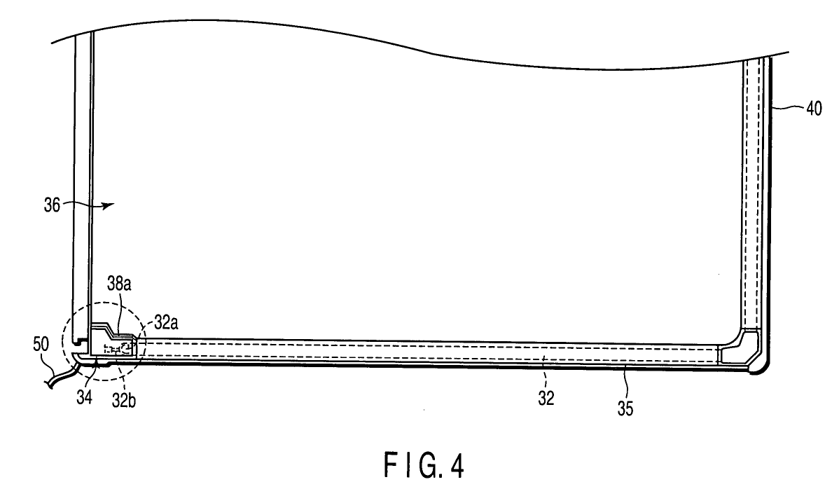

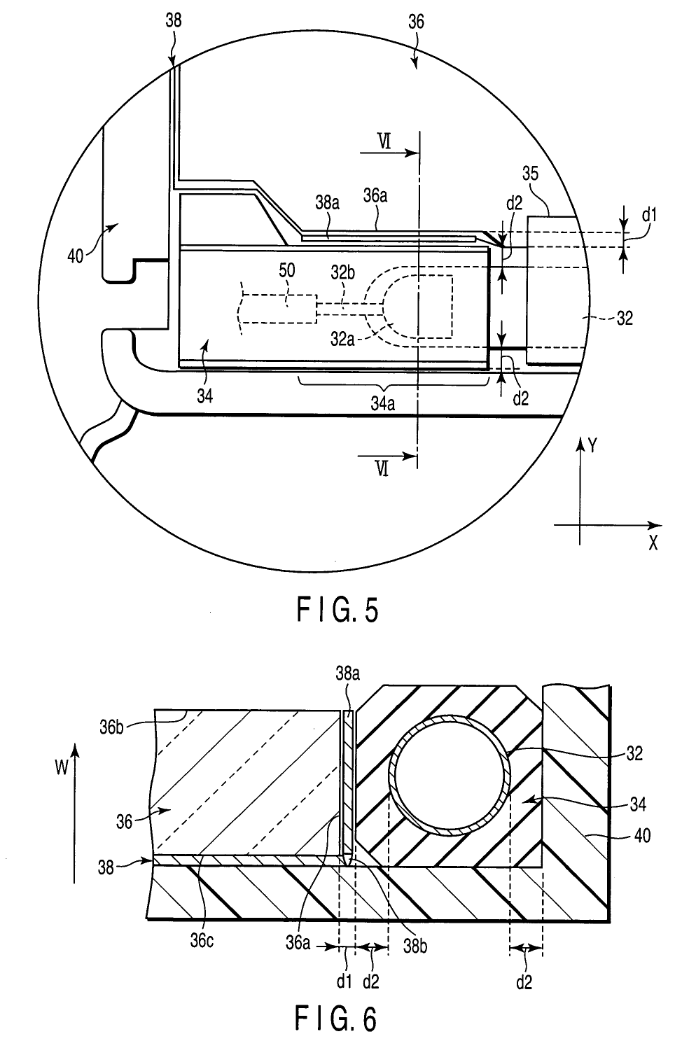

FIG. 4 is a plan view of the planar light source device 30. FIG. 5 is an enlarged view showing an end portion of the cold cathode fluorescent tube 32 of the planar light source device 30 shown in FIG. 4. For the sake of explanation, the optical sheet 39 is omitted from these figures. As shown in FIG. 4, the cold cathode fluorescent tube 32 is arranged along the adjacent end surfaces 36a of the light guide 36. As shown in FIGS. 4 and 5, each end of the cold cathode fluorescent tube 32 has an electrode portion 32a and a connecting portion 32b connected to a feeding wire 50. The electrode portion 32a is connected to the feeding wire 50 through the connecting portion 32b.

The holder 34 has a holding portion 34a which holds the electrode portion 32a and the connecting portion 32b of the cold cathode fluorescent tube 32. The electrode portion 32a is held such that a distance d2 from the side surface of the holding portion 34a is about 0.6 mm. The holding portion 34a of the holder 34 is arranged to provide a gap at a predetermined distance d1 from the end surface 36a of the light guide 36. The tongue portion 38a of the reflecting sheet 38 is located between the light guide 36 and the holding portion 34a. In this embodiment, the distance d1 is about 0.3 mm.

The tongue portion 38a has a width (in the X direction) longer than the length of the holding portion 34a of the holder 34.

FIG. 6 is a cross-sectional view of an end portion the cold cathode fluorescent tube 32 shown in FIG. 5 taken along the line VI-VI. The tongue portion 38a projects from the reflecting sheet 38. It is bent along the end surface 36a of the light guide 36, and interposed between the end surface 36a and the holding portion 34a of the holder 34. The slit 38b is formed in a position at which the tongue portion 38a is bent. The length of the tongue portion 38a projected from the reflecting sheet 38 is the same as or longer than the height of the light guide 36 (in the W direction).

As described above, the tongue portions 38a are formed in the reflecting sheet 38 made of a material having heat resistance to a higher temperature than that of the light guide 36, and each tongue portion is interposed between the end surface 36a and the light guide 36 and the holding portion 34a of the holder 34. With this structure, the heat conduction from the electrode portions 32a and the connecting portions 32b of the cold cathode fluorescent tube 32 to the light guide 36 is suppressed. For this reason, if the cold cathode fluorescent tube of the gas pressure of 120 Torr is used, the light guide 36 is prevented from thermally deforming.

As a result, it is possible to provide a planar light source device, in which the brightness at the startup time is high and the light guide is prevented from thermally deforming, and also to provide a liquid crystal display apparatus comprising the planar light source device. In addition, since the slit 38b is formed in a position at which the tongue portion 38a is bent, the tongue portion 38 is easily bent.

In the above embodiment, parts of the light guide are cut. However, since the cut portions are near the electrode portions 32a of the cold cathode fluorescent tube 32, they do not adversely affect the brightness of the planar light source device 30.

The present invention is not limited to the above embodiment, and the structural elements can be modified when practiced, without departing from the scope of the invention. Further, the present invention can be variously modified by suitably combining a plurality of elements of the embodiments disclosed above. For example, some of the elements may be deleted from all elements of the embodiment. Furthermore, elements of different embodiments may be suitably combined.

In the above embodiment, the gap of the predetermined distance d1 of about 0.3 mm is provided between the end surface 36a of the light guide 36 and the holding portion 34a of the holder 34. However, the gap of the predetermined distance d1 is not necessarily required. However, if the gap of the predetermined distance d1 from about 0.15 mm to about 0.3 mm is provided, the heat conduction from the holder 34 to the light guide 36 can be suppressed more effectively.

Further, in the above embodiment, the tongue portions 38a are provided in the reflecting sheet 38. However, they may be provided in the optical sheet 39. In this case, the optical sheet 39 is formed of a material having heat resistance higher than that of the light guide 36. Each tongue portion, projecting from the optical sheet 39, is bent along the end surface 36a from above the light guide, and interposed between the end surface 36a and the holding portion 34a. If the tongue portion is formed in the optical sheet 39 in this way, the same advantage as that in the above embodiment can be obtained.

The cold cathode fluorescent tube 32, which serves as the light source in the above embodiment, is substantially L-shaped. However, a substantially straight cold cathode fluorescent tube may be used. In this case also, the same advantage as that in the above embodiment can be obtained by arranging the tongue portions projecting from the optical sheet between the light guide and the holders which hold the end portion of the cold cathode fluorescent tube. In the case where the straight cold cathode fluorescent tube is used, the light guide may have a wedge shape, whose thickness becomes gradually smaller along a normal to the end surface facing the light source as the distance from the light source increases. With this shape, space for the circuit board is provided on the back side of the planar light source device. Thus, the liquid crystal display apparatus can be thinner.

What is claimed is:

1. A planar light source device comprising:
a cylindrical light source having ends, which are held by holders;
a light guide having an end surface facing the light source and the holders, a light exit surface from which light exits, and a counter surface opposing to the light exit surface; and
an optical sheet, which is arranged to face at least one of the light exit surface and the counter surface,
wherein the optical sheet has tongue portions, each arranged between the light guide and each of the holders.

2. The planar light source device according to claim 1, wherein:
the light source has an electrode portion and a connecting portion at each of the ends;
each of the holders has a holding portion which holds the electrode portion and the connecting portion; and
each of the tongue portions is arranged between the light guide and the holding portion.

3. The planar light source device according to claim 1, wherein the optical sheet has heat resistance higher than that of the light guide.

4. The planar light source device according to claim 1, wherein:
the end surface of the light guide extends between the light exit surface and the counter surface, and faces the holders with a gap provided therebetween; and
each of the tongue portions is arrange between the end surface and each of the holders.

5. The planar light source device according to claim 1, wherein the tongue portion projects from the optical sheet and bent along the end surface.

6. The planar light source device according to claim 1, wherein the optical sheet is arranged on the counter surface of the light guide.

7. The planar light source device according to claim 6, wherein the optical sheet arranged on the counter surface is a reflecting sheet, which reflects light that exits though the counter surface out of the light guide to return the light to the light guide.

8. The planar light source device according to claim 1, wherein the optical sheet is arranged on the light exit surface of the light guide.

9. A liquid crystal display apparatus comprising:
a liquid crystal display panel including a display region in which a plurality of pixels are arrayed;
a planar light source device, which illuminates the liquid crystal display panel from behind it, according to claim 1; and
a frame which supports the liquid crystal display panel and the planar light source device.
